(19) United States
(12) Patent Application Publication
(10) Pub. No.: US 2025/0043454 A1
(43) Pub. Date: Feb. 6, 2025

(54) SILVER-PLATED MATERIAL PRODUCTION METHOD AND SILVER-PLATED MATERIAL

(71) Applicant: DOWA METALTECH CO., LTD., Tokyo (JP)

(72) Inventors: Yutaro HIRAI, Tokyo (JP); Kentaro ARAI, Tokyo (JP); Yosuke SATO, Tokyo (JP); Eri FUNADA, Tokyo (JP)

(21) Appl. No.: 18/714,141

(22) PCT Filed: May 27, 2022
(86) PCT No.: PCT/JP2022/021736

§ 371 Date: May 29, 2024

(30) Foreign Application Priority Data
Feb. 8, 2022 (JP) 2022-018313

(51) Int. Cl. C25D 3/46

(52) U.S. Cl. CPC C25D 3/46

(57) ABSTRACT

A silver-plated material has excellent abrasion resistance and has such performance that the resistance to peeling of a silver coating layer is maintained high even when the silver-plated material is exposed to a high temperature and high humidity environment. The silver-plated material is obtained by a production method, in which when a silver plating layer is formed on a material by an electroplating method using a cyanide-containing silver plating solution, as the silver plating solution, an aqueous solution, in which a benzothiazole or a derivative thereof, and a selenium-containing substance are dissolved, a selenium concentration is 0.9 to 120 mg/L, and a molar ratio of selenium to the benzothiazole or the derivative thereof is 0.08×10⁻³ or more, is used. As a substance corresponding to the benzothiazole or the derivative thereof, for example, mercaptobenzothiazole or a derivative thereof can be used.

### TECHNICAL FIELD

The present invention relates to a production method for a silver-plated material useful as a material of a contact of a connector, a switch, a relay, or the like used in electrical wiring for automotive or consumer use, as well as a material of a terminal component, and relates to the silver-plated material.

### BACKGROUND ART

Conventionally, as a material of a contact of a connector, a switch, or the like, a terminal component, or the like, plated materials obtained by plating a material, which is relatively inexpensive and has excellent corrosion resistance and mechanical properties, such as copper, a copper alloy, or stainless steel, with tin, silver, gold, or the like according to a necessary property such as an electrical property or solderability are used. Among these, a tin-plated material is inexpensive, but has poor corrosion resistance in a high temperature environment. A gold-plated material has excellent corrosion resistance and high reliability, but is expensive. Meanwhile, a silver-plated material has advantages of being less expensive than a gold-plated material and superior in corrosion resistance to a tin-plated material.

A material of a contact of a connector, a switch, or the like, a terminal component, or the like is also required to have resistance to abrasion due to insertion and removal of a connector or sliding of a switch. However, a silver-plated material is soft and easily abrades, and therefore, when a silver-plated material is used as a material of a connection terminal or the like, there are problems such that the material adheres due to insertion and removal, or sliding, and adhesive abrasion is more likely to occur, or the surface is abraded when a connection terminal is inserted to increase the coefficient of friction, and the insertion force increases.

The present applicant has disclosed a technique for obtaining a silver-plated material having excellent abrasion resistance as compared with a conventional one in PTL 1. The technique is configured to use a plating solution containing a predetermined amount of a benzothiazole or a derivative thereof.

### CITATION LIST

### Patent Literature

PTL 1: JP6916971B

### SUMMARY OF INVENTION

### Technical Problem

According to the technique disclosed in PTL 1, the abrasion resistance of the silver plating layer can be significantly improved as compared with a conventional one. However, it was found that in the technique of PTL 1, a problem occurs such that when the obtained silver-plated material is exposed to a severe environment of high temperature and high humidity, the resistance to peeling of the silver coating layer from the underlying layer deteriorates. Here, the “silver coating layer” is a silver film formed on the surface of a material, and for example, when the silver plating layer is formed on a silver strike plating layer, the entire silver film in which the silver strike plating layer and the silver plating layer thereon are integrated with each other is referred to as a silver coating layer.

An object of the invention is to provide a silver-plated material which has excellent abrasion resistance and has such performance that the resistance to peeling of a silver coating layer is maintained high even when the silver-plated material is exposed to a high temperature and high humidity environment.

### Solution to Problem

As a result of studies, the inventors found that by applying a silver plating solution in which a benzothiazole or a derivative thereof and a predetermined amount of selenium are added in combination, deterioration of the resistance to peeling of a silver coating layer due to the addition of a benzothiazole or a derivative thereof can be prevented.

The above object is achieved by a silver-plated material production method in which when a silver plating layer is formed on a material by an electroplating method using a cyanide-containing silver plating solution, as the silver plating solution, an aqueous solution, in which a benzothiazole or a derivative thereof, and a selenium-containing substance are dissolved, a selenium concentration is 0.9 to 120 mg/L, and a molar ratio of selenium to the benzothiazole or the derivative thereof is 0.08×10⁻³ or more, is used. It is more preferred that the molar ratio of selenium to the benzothiazole or the derivative thereof is 2.5×10⁻³ or more and 10.0×10⁻³ or less. As the benzothiazole or the derivative thereof, for example, mercaptobenzothiazole or a derivative thereof can be exemplified.

As the material, a material that has an underlying silver plating layer, that is, a silver plating layer as an underlying plating layer on a surface can be applied. In particular, as the material, a material that has a nickel plating layer on a base material made of copper or a copper alloy, and has an underlying silver plating layer on the nickel plating layer can be applied. The underlying silver plating layer of the present application means silver electroplating for an underlying treatment, which is referred to as so-called silver strike plating.

Further, in the invention, a silver-plated material having a silver electroplating layer, which contains C, S, N, K, and Se in the following proportions with respect to the total mass of Ag, C, S, N, K, and Se: C: 0.8 to 2.0% by mass, S: 0.5 to 1.5% by mass, N: 0.1 to 0.5% by mass, K: 0.2 to 1.0% by mass, and Se: 0.03 to 0.5% by mass, and has a C/S molar ratio of 3.0 to 6.0 and a S/N molar ratio of 1.0 to 4.0, on a material including copper or a copper alloy as a base material, is provided as a silver-plated material that is obtained by the above-mentioned production method and has excellent abrasion resistance and excellent resistance to peeling of a silver coating layer. In this case, as the material including copper or a copper alloy as a base material, for example, a material having a nickel plating layer on a base material made of copper or a copper alloy can be applied. When such a material is applied, a surface layer portion of the silver-plated material has a laminate structure including a nickel plating layer on a base material made of copper or a copper alloy, and a silver electroplating layer having the above-mentioned predetermined composition thereon. The total content of Ag, C, S, N, K, and Se in the constituent elements of the silver plating layer is 99.0% by mass or more. Further, in the invention, an electric current carrying component formed using the silver-plated material as a material is provided.

### Advantageous Effects of Invention

In the invention, it was possible to improve the deterioration of the resistance to peeling of the silver coating layer after exposure to a high temperature and high humidity environment, which was a problem with the technique of PTL 1. That is, according to the invention, it was possible to provide a silver-plated material excellent in both abrasion resistance and resistance to peeling of the silver coating layer after exposure to a high temperature and high humidity environment.

### DESCRIPTION OF EMBODIMENTS

### [Silver Plating Solution]

In the silver-plated material production method of the invention, an electroplating method using a cyanide-containing silver plating solution is targeted. As for a cyanide-containing substance and a silver-containing substance which are main components of the cyanide-containing silver plating solution, conventionally known materials can be applied. For example, an aqueous solution containing potassium silver cyanide or silver cyanide and potassium cyanide or sodium cyanide is suitable.

In the invention, a benzothiazole or a derivative thereof is applied as an additive to the plating solution. This point is the same as the technique of PTL 1. Benzothiazole (C₇H₅NS) is a heterocyclic compound having a benzene skeleton and a thiazole skeleton. The benzothiazole is preferably a benzothiazole having a mercapto group (—SH) such as 2-mercaptobenzothiazole. In addition, as the derivative of the benzothiazole, sodium 2-mercaptobenzothiazole (sodium mercaptobenzothiazole (SMBT)), zinc-2-mercaptobenzothiazole, 5-chloro-2-mercaptobenzothiazole, 6-amino-2-mercaptobenzothiazole, 6-nitro-2-mercaptobenzothiazole, 2-mercapto-5-methoxybenzothiazole, or the like can be used. Among these derivatives of benzothiazoles, alkali metal salts of benzothiazoles are preferred, and for example, sodium salts of benzothiazoles such as sodium 2-mercaptobenzothiazole (sodium mercaptobenzothiazole (SMBT)) are preferred.

It is considered that when silver electroplating is performed by adding a benzothiazole such as mercaptobenzothiazole or an alkali metal salt (preferably a sodium salt) thereof as an organic additive to a cyanide-based silver plating solution in this manner, a component derived from the organic additive is incorporated in the silver plating layer to be formed to improve the abrasion resistance. Further, it is considered that the coefficient of friction of the surface layer can be decreased by the lubricating effect of the organic additive. By the decrease in the coefficient of friction, when the silver-plated material is used as a material of a connection terminal or the like, the occurrence of adhesion due to insertion and removal, or sliding is prevented. It is assumed that this is also effective in improving the abrasion resistance.

However, when a material subjected to silver electroplating in a silver plating solution formed using a benzothiazole or a derivative thereof as an additive is exposed to a high temperature and high humidity environment, a phenomenon in which the resistance to peeling of the silver coating layer deteriorates occurs. When silver electroplating is performed, it is common to perform silver strike plating to form an underlying silver plating layer prior to the final silver plating in order to ensure the plating adhesion to the material. When silver electroplating is performed in a silver plating solution in which a benzothiazole or a derivative thereof is added, even if a silver strike plating layer is formed on the underlying layer, peeling of the silver coating layer (the silver strike plating layer+the silver plating layer) is more likely to occur between the silver strike plating layer and the underlying layer (for example, a nickel plating layer) after exposure to a high temperature and high humidity environment. In particular, the peeling resistance deteriorates in a portion where the current density is considered to have been high, a problem that when the obtained silver-plated material is tested by being held in a high temperature and high humidity environment and then subjected to severe bending, the silver coating layer peels off mainly in a portion where the current density is considered to have been high becomes apparent. The reason for this has not been fully elucidated, but it is thought that, in a portion where the current density is high, a crystalline state in which peeling is likely to occur is formed when a benzothiazole or a derivative thereof is incorporated, and it is assumed that this may decrease the adhesion of the silver coating layer after being held under high temperature and high humidity.

In the invention, a water-soluble selenium-containing substance is applied as another additive to the plating solution. That is, a benzothiazole or a derivative thereof and a selenium-containing substance are added in combination. It was found that this remarkably prevents the deterioration of the resistance to peeling of the silver coating layer described above. The mechanism is not clear at present, but it is considered that selenium present in the plating solution prevents the incorporation of a benzothiazole or a derivative thereof in a portion where the current density is high to form a crystalline state of silver in which peeling is less likely to occur. In the silver plating solution used in the invention, it is not necessary to add Sb.

It is effective to set the concentration of selenium in the silver plating solution within a range of 0.9 to 120 mg/L, and it is particularly effective to set the concentration of selenium within a range of 50 to 120 mg/L. Further, the molar ratio of selenium and the benzothiazole or the derivative thereof in the silver plating solution is preferably set to 0.08×10⁻³ or more, and more preferably set within a range of 2.5×10⁻³ or more and 10.0×10⁻³ or less.

The concentration of free cyanide in the silver plating solution can be set, for example, within a range of 3 to 60 g/L, and is more preferably set to 4 to 57 g/L, and even more preferably 4 to 40 g/L. The concentration of free cyanide in the silver plating solution can be obtained by diluting the silver plating solution with water, adding an aqueous solution of potassium iodide thereto, and then dropping an aqueous solution of silver nitrate therein until the silver plating solution becomes cloudy, and determining the concentration of free cyanide based on the dropping amount.

The concentration of the benzothiazole moiety in the silver plating solution can be set, for example, within a range of 2 to 50 g/L, and is preferably set to 2.5 to 45 g/L, more preferably 5 to 40 g/L, and still more preferably 10 to 35 g/L. Here, the “benzothiazole moiety” refers to a moiety corresponding to benzothiazole (C₇H₅NS) (molecular weight: 135.19).

The concentration of silver in the silver plating solution can be set, for example, within a range of 15 to 150 g/L, and is more preferably set to 30 to 120 g/L. The concentration of potassium silver cyanide or silver cyanide in the silver plating solution can be set, for example, within a range of 30 to 220 g/L, and is more preferably set to 50 to 200 g/L. The concentration of potassium cyanide or sodium cyanide in the silver plating solution can be set, for example, within a range of 30 to 150 g/L, and is more preferably set to 35 to 145 g/L, and still more preferably 38 to 110 g/L. The concentration of the benzothiazole or the alkali metal salt thereof in the silver plating solution can be set, for example, within a range of 15 to 70 g/L, and may be controlled within a range of 20 to 50 g/L. However, the concentration of the benzothiazole or the alkali metal salt thereof is set so that the molar ratio of selenium and the benzothiazole or the derivative thereof in the silver plating solution is within the above-described range of 0.08×10⁻³ or more, and more preferably within the range of 2.5×10⁻³ or more and 10.0×10⁻³ or less.

### [Silver Plating Conditions]

The silver electroplating using the above-mentioned silver plating solution is preferably performed at a liquid temperature of 15 to 50° C., more preferably at a liquid temperature of 18 to 47° C. The current density in this silver electroplating can be set, for example, within a range of 0.5 to 10 A/dm², and more preferably 0.5 to 8 A/dm². In order to efficiently form a good silver plating layer with few defects, it is preferred to ensure a current density of 1.5 A/dm² or more, and more preferably 2.5 A/dm² or more. The plating time may be set according to the application so that the average film thickness of the silver plating layer formed by the silver electroplating is within a range of, for example, 0.5 to 10 μm, preferably 0.8 to 8 μm, and more preferably 0.8 to 3 μm.

### [Material to be Plated]

As a material to be subjected to the above-mentioned silver electroplating, that is, a material to be plated is preferably a material including copper or a copper alloy as a base material in consideration of use of an electric current carrying component. When the base material is copper or a copper alloy, it is preferred to apply a material in which an underlying plating layer such as a nickel plating layer is formed on the surface of a copper-based metal serving as the base material from the viewpoint of sufficiently ensuring the adhesion of the silver coating layer to the base material. Further, it is more preferred to apply a material in which an underlying plating layer such as a nickel plating layer is formed on the surface of a copper-based metal serving as the base material, and further an underlying silver plating layer (a silver strike plating layer) is formed on the underlying plating layer.

### [Silver-Plated Material]

By the silver electroplating using the plating solution described above, it is possible to obtain a silver-plated material having a silver electroplating layer, which contains C, S, N, K, and Se in the following proportions with respect to the total mass of Ag, C, S, N, K, and Se: C: 0.8 to 2.0% by mass, S: 0.5 to 1.5% by mass, N: 0.1 to 0.5% by mass, K: 0.2 to 1.0% by mass, and Se: 0.03 to 0.5% by mass, and has a C/S molar ratio of 3.0 to 6.0 and a S/N molar ratio of 1.0 to 4.0, on a material including copper or a copper alloy as a base material. The silver electroplating layer having such a composition has excellent abrasion resistance, and also has good adhesion to the underlying layer, and exhibits good peeling resistance in a bent portion. In particular, a silver electroplating layer in which the Se content is adjusted to 0.05 to 0.2% by mass has further improved adhesion. The C/S molar ratio and the S/N molar ratio are achieved by incorporating a component derived from the benzothiazole or the derivative thereof described above in the silver plating layer. In the silver electroplating layer, elements (such as Na and O) that are unavoidably mixed from the plating solution or the like may be contained, but the total content of Ag, C, S, N, K, and Se in the constituent elements of the silver electroplating layer is preferably 99.0% by mass or more, more preferably 99.5% by mass or more, and even more preferably 99.8% by mass or more.

When a silver electroplating layer is formed using the above-mentioned silver plating solution on a silver strike plating layer (for example, a thickness of about 0.01 to 0.02 μm), the silver electroplating layer specified by the above-mentioned composition means a silver coating layer in which a silver strike plating layer and a silver electroplating layer formed thereon using the above-mentioned silver plating solution are integrated with each other.

The average thickness of the silver coating layer in the silver-plated material according to the invention (when a silver electroplating layer is formed using the above-mentioned silver plating solution on a silver strike plating layer, the total average thickness of the silver coating layer in which these layers are integrated with each other) is preferably set, for example, within a range of 0.5 to 10 μm, and is more preferably set to 0.8 to 8 μm, and still more preferably 0.8 to 3 μm. In addition, the average crystallite size of the silver coating layer in the silver-plated material according to the invention can be set to 25 nm or less, and is more preferably 8 to 15 nm. The crystallite size of the silver plating layer can be controlled, for example, by adjusting the current density, the composition of the plating solution, the liquid temperature, or the like.

A representative form of the silver-plated material according to the invention is a plate material having a silver plating layer on a surface on at least one side. The plate thickness can be set to, for example, 0.05 to 3.5 mm, more preferably 0.1 to 3.0 mm. Here, the “plate material” means a sheet-shaped metal material. A thin sheet-shaped metal material is sometimes called “foil”, and such a “foil” is also included in the “plate material” as used herein. A long sheet-shaped metal material wound into a coil is also included in the “plate material”. Further, the thickness of the sheet-shaped metal material is referred to as “plate thickness”.

### [Electric Current Carrying Component]

An electric current carrying component such as a connector, a switch, or a relay can be obtained by processing the above-mentioned silver-plated material by a known method. In the electric current carrying component formed using the silver-plated material according to the invention, it is effective that the silver electroplating layer having the above-mentioned composition (that is, the above-mentioned silver coating layer) has a structure forming a portion that can come into sliding contact with a counter contact material.

### EXAMPLES

### Comparative Example 1

### (Pre-Treatment)

A rolled plate of 67 mm×50 mm×0.3 mm made of oxygen-free copper (C1020, 1/2H) was prepared as a base material. Electrolytic degreasing was performed at a voltage of 5 V for 30 seconds in an alkaline degreasing solution using the base material as a cathode and a stainless steel plate as an anode. The base material was washed with water, and thereafter pickled by immersion in a 3% sulfuric acid aqueous solution for 15 seconds. The base material with the surfaces cleaned in this manner was sequentially subjected to respective plating operations by the following steps to produce a silver-plated material.

### (Underlying Nickel Plating Step)

In a matte nickel plating solution made of an aqueous solution containing 540 g/L of nickel sulfamate tetrahydrate, 25 g/L of nickel chloride, and 35 g/L of boric acid, electroplating was performed for 80 seconds under the conditions of a liquid temperature of 50° C. and a current density of 5 A/dm² using the pre-treated base material as a cathode and a nickel electrode plate as an anode while stirring at 500 rpm with a stirrer to form a matte underlying nickel plating layer on the base material. The thickness of the underlying nickel plating layer in a central portion of the surface of this plate material sample was measured with a fluorescent X-ray film thickness meter (SFT-110A, manufactured by Hitachi High-Tech Science Co., Ltd.) and found to be about 1 μm.

### (Silver Strike Plating Step)

In a silver strike plating solution made of an aqueous solution containing 3 g/L of potassium silver cyanide (K[Ag(CN)₂]) and 90 g/L of potassium cyanide (KCN), electroplating was performed at a current density of 2.0 A/dm² for 10 seconds at room temperature (25° C.) using the plate material sample in which the underlying nickel plating layer was formed as a cathode and a titanium electrode plate coated with platinum as an anode while stirring at 500 rpm with a stirrer to form an underlying silver plating layer by silver strike plating. Thereafter, water washing was performed to sufficiently wash away the silver strike plating solution.

### (Silver Plating Step)

In a silver plating solution made of an aqueous solution containing 175 g/L of potassium silver cyanide (K[Ag(CN)₂]), 95 g/L of potassium cyanide (KCN), and 30 g/L of sodium 2-mercaptobenzothiazole (C₇H₄NNaS₂), electroplating was performed for 18 seconds under the conditions of a liquid temperature of 35° C. and a current density of 7 A/dm² using the plate material sample in which the underlying silver plating layer was formed by silver strike plating as a cathode and a silver electrode plate as an anode while stirring at 500 rpm with a stirrer to form a silver plating layer. The concentration of free cyanide in the silver plating solution is 38 g/L, and the concentration of the benzothiazole moiety therein is 21 g/L. The total thickness of the underlying silver plating layer formed by silver strike plating and the silver plating layer of the upper layer formed thereon in this step (that is, the thickness of the silver coating layer) in a central portion of the surface of this plate material sample was measured with the fluorescent X-ray film thickness meter and found to be about 1 μm. In this example, selenium is not added to the silver plating solution. In this manner, a silver-plated material having the silver coating layer on both surfaces of the plate material was obtained. The blending composition of the plating solution and the plating conditions for the silver plating step are shown in Table 1 (the same applies to the following respective examples).

The obtained silver-plated material was used as a test material and subjected to the following tests.

### (Constant Temperature and Constant Humidity Test)

The test material was placed in a constant temperature and constant humidity tester and held for 120 hours under the conditions of a temperature of 85° C. and a humidity of 85%.

### (Bending Test)

The plate material after being subjected to the constant temperature and constant humidity test was bent 180° by hand, and thereafter, the bent portion was bent back to approximately the original plate shape, and the outer and inner surfaces of the bent portion were observed to examine whether peeling of the silver coating layer occurs. In this bending test, a test material in which no peeling of the silver coating layer was observed on both outer and inner surfaces of the bent portion was evaluated as A (peeling resistance: good), and the others were evaluated as B (peeling resistance: poor), and a test material evaluated as A was determined to be acceptable. The test material obtained in this example was evaluated as B.

### (Cross-Cut Peeling Test)

With respect to the plate material after being subjected to the constant temperature and constant humidity test, the resistance to peeling of the silver coating layer was examined in accordance with the peeling test method using an adhesive tape specified in section 15.1 of JIS H 8504:1999 as a more severe evaluation of peeling resistance. Here, in order to adopt a severe standard, a sample was prepared by forming cross-cuts on the silver-plated surface with a utility knife, and subjected to a peeling test. Specifically, linear cuts were made at intervals of about 3 mm in one direction over the entire surface on one side of the plate material which is the test material, and linear cuts were made at intervals of about 3 mm in a direction perpendicular to the cuts to form squares with a side of about 3 mm. With respect to all the squares, the peeling test using an adhesive tape was performed, and a test material in which peeling of the silver coating layer was observed in even one square was evaluated as B, and the others were evaluated as A. The material evaluated as A in this test can be evaluated as having excellent peeling resistance equal to or higher than that of conventional general silver-plated materials. Note that even if a material is evaluated as B in this test, when the material is evaluated as A in the above-mentioned bending test, it is evaluated that the resistance to peeling of the silver coating layer has been significantly improved as compared with a silver-plated material obtained by the technique of PTL 1, and it is considered that practical problems will not arise in many applications.

### (Reciprocating Sliding Test)

Two silver-plated materials, which are test materials, were prepared, and one silver-plated material was indented (inner radius R=1.5 mm) and used as an indenter, and the other silver-plated material was used as a flat plate-shaped evaluation sample, and reciprocating sliding motion (sliding distance: 5 mm, sliding speed: 1.67 mm/s) was applied while pressing the indenter against the evaluation sample with a constant load (5 N) using a precision sliding tester (CRS-G2050-DWA, manufactured by Yamasaki Seiki Kenkyusho, Inc.). With respect to the evaluation sample at a stage where this reciprocating sliding test was performed up to a predetermined number of times, a sliding mark was observed with a microscope (VHX-1000 manufactured by Keyence Corporation) at a magnification of 100 times to examine the abrasion state of the silver coating layer. In a material having a silver coating layer with a film thickness of about 1 μm, when copper of the base material is not exposed on the sliding mark at a stage where the number of reciprocating sliding times is 100 under the test conditions, it can be determined that the silver coating layer has excellent abrasion resistance. Therefore, a test material in which exposure of copper of the base material was observed on the sliding mark at a stage where the number of reciprocating sliding times was 100 was evaluated as B (abrasion resistance: insufficient), and the others were evaluated as A (abrasion resistance: good). In the test material of this example, exposure of copper of the base material was not observed at a stage where the number of sliding times was 200, and exposure of copper of the base material was observed at a stage where the number of sliding times was 400, and therefore, the abrasion resistance was evaluated as A. In this case, the number of sliding times at which exposure of copper of the base material occurred is indicated as “more than 200 and 400 or less” in Table 2.

The above results are shown in Table 2 (the same applies to the following respective examples).

### Comparative Example 2

An experiment was performed under the same conditions as in Comparative Example 1 except that a silver plating solution in which the concentration of selenium was adjusted to 0.5 mg/L by adding potassium selenocyanate was applied in the silver plating step performed after the silver strike plating step (hereinafter simply referred to as the “silver plating step”).

In the plating solution used in the silver plating step, the types and addition amounts of the added substances other than the selenium-containing substance are the same as in Comparative Example 1 (the same applies to the following respective examples unless otherwise specified).

The obtained silver-plated material failed the bending test, and the improvement in resistance to peeling of the silver coating layer was insufficient.

### Example 1

An experiment was performed under the same conditions as in Comparative Example 1 except that a silver plating solution in which the concentration of selenium was adjusted to 1.3 mg/L was applied in the silver plating step. The type of the selenium-containing substance used is the same as in Comparative Example: 2 (the same applies to the following respective examples unless otherwise specified).

The obtained silver-plated material passed the bending test, and the effect of improving the resistance to peeling of the silver coating layer by adding selenium to the plating solution was verified.

### Example 2

An experiment was performed under the same conditions as in Comparative Example 1 except that a silver plating solution in which the concentration of selenium was adjusted to 12.7 mg/L was applied in the silver plating step.

The obtained silver-plated material passed the bending test, and the effect of improving the resistance to peeling of the silver coating layer by adding selenium to the plating solution was verified.

### Example 3

An experiment was performed under the same conditions as in Comparative Example 1 except that a silver plating solution in which the concentration of selenium was adjusted to 25.4 mg/L was applied in the silver plating step.

The obtained silver-plated material passed the bending test, and the effect of improving the resistance to peeling of the silver coating layer by adding selenium to the plating solution was verified.

### Example 4

An experiment was performed under the same conditions as in Comparative Example 1 except that a silver plating solution in which the concentration of selenium was adjusted to 38.1 mg/L was applied in the silver plating step. The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 5

An experiment was performed under the same conditions as in Comparative Example 1 except that a silver plating solution in which the concentration of selenium was adjusted to 50.8 mg/L was applied in the silver plating step.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 6

An experiment was performed under the same conditions as in Comparative Example 1 except that a silver plating solution in which the concentration of selenium was adjusted to 76.2 mg/L was applied in the silver plating step.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 7

An experiment was performed under the same conditions as in Comparative Example 1 except that a silver plating solution in which the concentration of selenium was adjusted to 101.6 mg/L was applied in the silver plating step.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 8

An experiment was performed under the same conditions as in Comparative Example 1 except that a silver plating solution in which the concentration of sodium 2-mercaptobenzothiazole was adjusted to 25 g/L and the concentration of selenium was adjusted to 71.1 mg/L was applied, the liquid temperature during plating was set to 25° C., the current density was set to 3 A/dm², and the energization time was set to 43 seconds in the silver plating step. The concentration of free cyanide in the silver plating solution is 38 g/L, and the concentration of the benzothiazole moiety therein is 18 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 9

An experiment was performed under the same conditions as in Comparative Example 1 except that a silver plating solution in which the concentration of sodium 2-mercaptobenzothiazole was adjusted to 25 g/L and the concentration of selenium was adjusted to 71.1 mg/L was applied, the liquid temperature during plating was set to 25° C., the current density was set to 5 A/dm², and the energization time was set to 24 seconds in the silver plating step. The concentration of free cyanide in the silver plating solution is 38 g/L, and the concentration of the benzothiazole moiety therein is 18 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 10

An experiment was performed under the same conditions as in Comparative Example 1 except that a silver plating solution in which the concentration of sodium 2-mercaptobenzothiazole was adjusted to 25 g/L and the concentration of selenium was adjusted to 71.1 mg/L was applied, the liquid temperature during plating was set to 45° C., the current density was set to 5 A/dm², and the energization time was set to 24 seconds in the silver plating step. The concentration of free cyanide in the silver plating solution is 38 g/L, and the concentration of the benzothiazole moiety therein is 18 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 11

An experiment was performed under the same conditions as in Comparative Example 1 except that a silver plating solution in which the concentration of sodium 2-mercaptobenzothiazole was adjusted to 35 g/L and the concentration of selenium was adjusted to 71.1 mg/L was applied, the liquid temperature during plating was set to 25° C., the current density was set to 3 A/dm², and the energization time was set to 43 seconds in the silver plating step. The concentration of free cyanide in the silver plating solution is 38 g/L, and the concentration of the benzothiazole moiety therein is 25 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 12

An experiment was performed under the same conditions as in Comparative Example 1 except that a silver plating solution in which the concentration of sodium 2-mercaptobenzothiazole was adjusted to 35 g/L and the concentration of selenium was adjusted to 71.1 mg/L was applied, the liquid temperature during plating was set to 25° C., the current density was set to 5 A/dm², and the energization time was set to 24 seconds in the silver plating step. The concentration of free cyanide in the silver plating solution is 38 g/L, and the concentration of the benzothiazole moiety therein is 25 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 13

An experiment was performed under the same conditions as in Comparative Example 1 except that a silver plating solution in which the concentration of sodium 2-mercaptobenzothiazole was adjusted to 35 g/L and the concentration of selenium was adjusted to 71.1 mg/L was applied, the liquid temperature during plating was set to 45° C., the current density was set to 3 A/dm², and the energization time was set to 43 seconds in the silver plating step. The concentration of free cyanide in the silver plating solution is 38 g/L, and the concentration of the benzothiazole moiety therein is 25 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Example 14

An experiment was performed under the same conditions as in Comparative Example 1 except that a silver plating solution in which the concentration of sodium 2-mercaptobenzothiazole was adjusted to 35 g/L and the concentration of selenium was adjusted to 71.1 mg/L was applied, the liquid temperature during plating was set to 45° C., the current density was set to 5 A/dm², and the energization time was set to 24 seconds in the silver plating step. The concentration of free cyanide in the silver plating solution is 38 g/L, and the concentration of the benzothiazole moiety therein is 25 g/L.

The obtained silver-plated material passed the bending test, and also in the cross-cut peeling test, no peeling of the silver coating layer was observed. In this example, the effect of improving the resistance to peeling of the silver coating layer by adding selenium to the plating solution was remarkably exhibited.

### Comparative Example 3

An experiment was performed under the same conditions as in Comparative Example 1 except that a silver plating solution in which sodium 2-mercaptobenzothiazole and the selenium-containing substance were not added was applied in the silver plating step. The concentration of free cyanide in the silver plating solution is 38 g/L, and the concentration of the benzothiazole moiety therein is 0 g/L.

The obtained silver-plated material had poor abrasion resistance.

### Comparative Example 4

An experiment was performed under the same conditions as in Comparative Example 1 except that a silver plating solution in which sodium 2-mercaptobenzothiazole was not added but potassium selenocyanate was added and the concentration of selenium was adjusted to 71.1 mg/L was applied in the silver plating step. The concentration of free cyanide in the silver plating solution is 38 g/L, and the concentration of the benzothiazole moiety therein is 0 g/L.

The obtained silver-plated material had poor abrasion resistance.

### [Composition Analysis of Silver Coating Layer]

With respect to some Comparative Examples and Examples, the elemental analysis of the silver coating layer including both of the underlying silver plating layer formed in the silver strike plating step and the silver plating layer formed in the subsequent silver plating step was performed as follows.

### Silver

The weight of the silver coating layer was calculated by subtracting the weight of the plate material sample before being subjected to the silver strike plating step from the weight of the silver-plated material which is the test material. After silver that covers the surface of the test material was dissolved in nitric acid, hydrochloric acid was added until no white precipitate of AgCl was formed, the white precipitate was filtered, washed with water, and the weight of AgCl was measured to calculate the weight of silver in the silver coating layer.

### Carbon and Sulfur

The silver-plated material, which is the test material, was melted by being heated to 1350° C. in an oxygen stream using a carbon/sulfur analyzer (EMIA-810, manufactured by Horiba, Ltd.), and the CO and CO₂ generated at that time were qualitatively and quantitatively determined by an infrared detector to calculate the carbon content in the test material. The carbon content was calculated in the same manner for the plate material sample before being subjected to the silver strike plating step, and found to be equal to or less than the detection limit. Therefore, the carbon content calculated for the test material was taken as the carbon content (g) in the silver coating layer.

In addition, the sulfur content in the test material was calculated by qualitatively and quantitatively determining SO₂ generated when the silver-plated material was melted by being heated to 1350° C. in an oxygen stream using an infrared detector. The sulfur content was calculated in the same manner for the plate material sample before being subjected to the silver strike plating step, and found to be equal to or less than the detection limit. Therefore, the sulfur content calculated for the test material was taken as the sulfur content (g) in the silver coating layer.

### Nitrogen

The silver-plated material, which is the test material, was melted in a helium stream at an electric power of 5000 W using an oxygen/nitrogen/hydrogen analyzer (manufactured by LECO Japan Corporation), and N₂ generated at that time was quantified using a thermal conductivity detector (TCD) to calculate the nitrogen content in the test material. The nitrogen content was calculated in the same manner for the plate material sample before being subjected to the silver strike plating step, and found to be equal to or less than the detection limit. Therefore, the nitrogen content calculated for the test material was taken as the nitrogen content (g) in the silver coating layer.

### Potassium

After the silver-plated material, which is the test material, was dissolved in nitric acid to form a liquid, the concentration of the solution was adjusted, and the concentration of potassium was measured by atomic absorption spectroscopy using an atomic absorption spectrometer (a polarized Zeeman atomic absorption spectrometer ZA3300, manufactured by Hitachi High-Tech Science Co., Ltd.) to obtain the potassium content (g) in the silver coating layer. The potassium content was calculated in the same manner for the plate material sample before being subjected to the silver strike plating step, and found to be equal to or less than the detection limit. Therefore, the potassium content for the test material was taken as the potassium content (g) in the silver coating layer.

### Selenium

Selenium was also analyzed in the following manner for a test material prepared by adding selenium to the silver plating solution. After the silver-plated material, which is the test material, was dissolved in nitric acid to form a liquid, the concentration of the solution was adjusted, and the concentration of selenium was measured by plasma spectroscopy using an ICP optical emission spectroscopy (ICP-OES) apparatus (SPS5100, manufactured by Seiko Instruments Inc.) to obtain the selenium content (g) in the silver coating layer. The selenium content was calculated in the same manner for the plate material sample before being subjected to the silver strike plating step, and found to be equal to or less than the detection limit. Therefore, the selenium content for the test material was taken as the selenium content (g) in the silver coating layer.

### C/S Molar Ratio and S/N Molar Ratio

The content (% by mass) of each element was obtained while the sum of the silver content (g), the carbon content (g), the sulfur content (g), the nitrogen content (g), the potassium content (g), and for the test material prepared by adding selenium in the silver plating solution, further the selenium content (g) in the silver coating layer obtained as described above was taken as 100%, and the molar ratio of carbon to sulfur C/S and the molar ratio of sulfur to nitrogen S/N were calculated.

These analysis results are shown in Table 2. In the silver coating layer, trace amounts of elements (such as Na and O) that are unavoidably mixed from the plating solution or the like are contained, but the total content of Ag, C, S, N, K, and Se in the constituent elements of the silver coating layer is 99.0% by mass or more.

TABLE 1

| | Silver plating step (*1) | | | | | | | |
|---|---|---|---|---|---|---|---|---|
| | Silver plating solution | | | | | | | |
| | Blended substance | | | | | | Plating conditions | |
| | | | SMBT | Ag | Se | Se/SMBT | Liquid | Current |
| | K[Ag(CN)₂] | KCN | (*2) | concentration | concentration | molar ratio | temperature | density |
| Example No. | (g/L) | (g/L) | (g/L) | (g/L) | (mg/L) | (×10⁻³) | (° C.) | (A/dm²) |
| Comparative | 175 | 95 | 30 | 95 | 0 | 0.00 | 35 | 7 |
| example 1 | | | | | | | | |
| Comparative | 175 | 95 | 30 | 95 | 0.5 | 0.04 | 35 | 7 |
| example 2 | | | | | | | | |
| Example 1 | 175 | 95 | 30 | 95 | 1.3 | 0.10 | 35 | 7 |
| Example 2 | 175 | 95 | 30 | 95 | 12.7 | 1.01 | 35 | 7 |
| Example 3 | 175 | 95 | 30 | 95 | 25.4 | 2.03 | 35 | 7 |
| Example 4 | 175 | 95 | 30 | 95 | 38.1 | 3.04 | 35 | 7 |
| Example 5 | 175 | 95 | 30 | 95 | 50.8 | 4.06 | 35 | 7 |
| Example 6 | 175 | 95 | 30 | 95 | 76.2 | 6.09 | 35 | 7 |
| Example 7 | 175 | 95 | 30 | 95 | 101.6 | 8.12 | 35 | 7 |
| Example 8 | 175 | 95 | 25 | 95 | 71.1 | 6.82 | 25 | 3 |
| Example 9 | 175 | 95 | 25 | 95 | 71.1 | 6.82 | 25 | 5 |
| Example 10 | 175 | 95 | 25 | 95 | 71.1 | 6.82 | 45 | 5 |
| Example 11 | 175 | 95 | 35 | 95 | 71.1 | 4.87 | 25 | 3 |
| Example 12 | 175 | 95 | 35 | 95 | 71.1 | 4.87 | 25 | 5 |
| Example 13 | 175 | 95 | 35 | 95 | 71.1 | 4.87 | 45 | 3 |
| Example 14 | 175 | 95 | 35 | 95 | 71.1 | 4.87 | 45 | 5 |
| Comparative | 175 | 95 | 0 | 95 | 0 | — | 35 | 7 |
| example 3 | | | | | | | | |
| Comparative | 175 | 95 | 0 | 95 | 71.1 | — | 35 | 7 |
| example 4 | | | | | | | | |

*1: silver plating step performed after silver strike plating step
*2: sodium 2-mercaptobenzothiazole

TABLE 2

| | Adhesion of silver | | Abrasion resistance of | | | | | | | | | |
|---|---|---|---|---|---|---|---|---|---|---|---|---|
| | coating layer | | silver coating layer | | | | | | | | | |
| | | | Number of sliding | | | | | | | | | |
| | Evaluation | Evaluation | times at which | Evaluation | Analysis results of silver coating layer | | | | | | | |
| | by | by | exposure of | by | | | | | | | C/S | S/N |
| Example | bending | cross-cut | copper of base | reciprocating | Composition (mass %) | | | | | | molar | molar |
| No. | test | peeling test | material occurred | sliding test | Ag | C | S | N | K | Se | ratio | ratio |
| Comparative | B | B | more than 200 | A | 98.0 | 1.0 | 0.64 | 0.1 | 0.213 | 0 | 4.17 | 2.80 |
| example 1 | | | and 400 or less | | | | | | | | | |
| Comparative | B | B | more than 200 | A | | | | | | | | |
| example 2 | | | and 400 or less | | | | | | | | | |
| Example 1 | A | B | more than 200 | A | | | | | | | | |
| | | | and 400 or less | | | | | | | | | |
| Example 2 | A | B | more than 200 | A | | | | | | | | |
| | | | and 400 or less | | | | | | | | | |
| Example 3 | A | B | more than 200 | A | | | | | | | | |
| | | | and 400 or less | | | | | | | | | |
| Example 4 | A | A | more than 200 | A | 97.3 | 1.2 | 0.81 | 0.2 | 0.443 | 0.054 | 3.95 | 1.77 |
| | | | and 400 or less | | | | | | | | | |
| Example 5 | A | A | more than 200 | A | 97.2 | 1.3 | 0.86 | 0.2 | 0.372 | 0.063 | 4.03 | 1.88 |
| | | | and 400 or less | | | | | | | | | |
| Example 6 | A | A | more than 100 | A | 97.0 | 1.3 | 1.02 | 0.2 | 0.357 | 0.092 | 3.40 | 2.23 |
| | | | and 200 or less | | | | | | | | | |
| Example 7 | A | A | more than 200 | A | 96.9 | 1.4 | 0.97 | 0.2 | 0.371 | 0.13 | 3.85 | 2.12 |
| | | | and 400 or less | | | | | | | | | |
| Example 8 | A | A | more than 400 | A | | | | | | | | |
| Example 9 | A | A | more than 400 | A | | | | | | | | |
| Example 10 | A | A | more than 400 | A | | | | | | | | |
| Example 11 | A | A | more than 400 | A | | | | | | | | |
| Example 12 | A | A | more than 400 | A | | | | | | | | |
| Example 13 | A | A | more than 400 | A | | | | | | | | |
| Example 14 | A | A | more than 400 | A | | | | | | | | |
| Comparative | A | A | 10 or less | B | | | | | | | | |
| example 3 | | | | | | | | | | | | |
| Comparative | A | A | 10 or less | B | 99.95 | 0 | 0 | 0 | 0 | 0.05 | — | — |
| example 4 | | | | | | | | | | | | |

1. A silver-plated material production method, wherein, when a silver plating layer is formed on a material by an electroplating method using a cyanide-containing silver plating solution, as the silver plating solution, an aqueous solution, in which a benzothiazole or a derivative thereof, and a selenium-containing substance are dissolved, a selenium concentration is 0.9 to 120 mg/L, and a molar ratio of selenium to the benzothiazole or the derivative thereof is 0.08×10⁻³ or more, is used.

2. The silver-plated material production method according to claim 1, wherein the molar ratio of selenium to the benzothiazole or the derivative thereof is 2.5×10⁻³ or more and 10.0×10⁻³ or less.

3. The silver-plated material production method according to claim 1, wherein as a substance corresponding to the benzothiazole or the derivative thereof, mercaptobenzothiazole or a derivative thereof is used.

4. The silver-plated material production method according to claim 1, wherein the material has an underlying silver plating layer on a surface.

5. The silver-plated material production method according to claim 1, wherein the material has a nickel plating layer on a base material made of copper or a copper alloy, and has an underlying silver plating layer on the nickel plating layer.

6. A silver-plated material, in which a silver plating layer containing C, S, N, K, and Se is formed on a material including copper or a copper alloy as a base material, wherein the silver plating layer contains the elements in the following proportions with respect to the total mass of Ag, C, S, N, K, and Se: C: 0.8 to 2.0% by mass, S: 0.5 to 1.5% by mass, N: 0.1 to 0.5% by mass, K: 0.2 to 1.0% by mass, and Se: 0.03 to 0.5% by mass, and has a C/S molar ratio of 3.0 to 6.0, and a S/N molar ratio of 1.0 to 4.0.

7. The silver-plated material according to claim 6, wherein the material including copper or a copper alloy as a base material has a nickel plating layer on the base material made of copper or a copper alloy.

8. The silver-plated material according to claim 6, wherein a total content of Ag, C, S, N, K, and Se in the constituent elements of the silver plating layer is 99.0% by mass or more.

9. An electric current carrying component formed using the silver-plated material according to claim 6.
